(19) United States
(12) Patent Application Publication
(10) Pub. No.: US 2014/0365530 A1
(43) Pub. Date: Dec. 11, 2014

(54) SYSTEMS AND METHODS TO EDIT A HIERARCHICAL TREE STRUCTURE

(71) Applicant: MediaGraph, LLC, Berkeley, CA (US)

(72) Inventors: Alex Kerfoot, Oakland, CA (US); Michael Evans, Oakland, CA (US); Orion Reblitz-Richardson, Berkeley, CA (US); Sina Jafarzadeh, San Francisco, CA (US); Ryan Shelby, San Leandro, CA (US); Randall Breen, San Rafael, CA (US); A. Peter Swearengen, San Francisco, CA (US); William Wright, Oakland, CA (US)

(21) Appl. No.: 14/336,997

(22) Filed: Jul. 21, 2014

Related U.S. Application Data
(63) Continuation of application No. 14/214,372, filed on Mar. 14, 2014.
(60) Provisional application No. 61/800,577, filed on Mar. 15, 2013.
(60) Provisional application No. 61/928,626, filed on Jan. 17, 2014.

(51) Int. Cl. G06F 17/30

(52) U.S. Cl. CPC G06F 17/30327
USPC 707/797

(57) ABSTRACT

Media items in a media library are organized into a hierarchical tree so that a particular media item can be found by referencing similar media items. The hierarchical tree has nodes that are the media items and each node further includes a prominence level that indicates a relative popularity of the media item. Systems and methods described herein allow a user to edit or modify the hierarchical tree by changing a position of a media item in the hierarchical tree or by changing a prominence level of the media item. If the edit or modification affects the integrity of the hierarchical tree, the hierarchical tree is automatically further modified to preserve the integrity while reflecting the edit or modification made by the user.

### PRIORITY

This non-provisional U.S. patent application is a continuation of U.S. patent application Ser. No. 14/214,372 filed Apr. 14, 2014 which claims priority to, and the benefit of, U.S. Provisional Patent Application No. 61/800,577 filed Mar. 15, 2013 and to U.S. Provisional Patent No. 61/928,626 filed Jan. 17, 2014, the entirety of each of which are hereby incorporated by reference herein.

### BACKGROUND

1. Field

This patent application is directed generally to data structures and data analysis, and, more specifically, to methods and systems to edit a hierarchical tree structure.

2. Description of Related Art

Systems exist in literature and industry for the classification and spatial display of collections of content such as digital data or media files. They span from the common linear directory structures on modern personal computers (such as Microsoft Windows Explorer or Apple Mac OS Finder) in which hierarchical structure can be created to organize content by user-defined classifications (for example, parent directories can be labeled as media, with sub-folders for music and movies, each containing associated music and movie files). Less common dimensional visualizations exist that represent files in an abstract 3D environment (such as File System Visualizer (FSV)).

Existing file system frameworks provide methods for a computer user to collect, classify and organize digital files or sets of files (folders) into tree structures which can be changed and ordered by hierarchy. However, these structures are not readily self-organizing and tend to embed files deep within them when the number of files in the system becomes significantly large. Without careful curation and attentive familiarity, existing methods can make it difficult to locate discrete files among many, deep within the folder tree structures. Mid-level nodes in a tree can make it difficult to locate a particular file within a set. For example the music folder is organized by artist but, without specific recollection, the artist's genre may not be readily apparent and thus that artist's connections to other similar artists may be difficult to maintain. As data collections increase in size and become more complex, new organization methods are required to aid in ordering and locating data (files) among many similar elements.

### SUMMARY

A method described herein comprises obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items; receiving an instruction from a user of the computing system to change the parent node of the second media item from the first media item to a third media item of the plurality of media items; changing, by the computing system, the hierarchical tree so that the third media item is the parent node of the second media item; detecting, by the computing system, that the prominence level of the second media item is not lower than the prominence level of the third media item; and changing, by the computing system, the prominence level of the second media item to be lower than the prominence level of the third media item.

A method described herein comprises obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items; receiving an instruction from a user of the computing system to change the prominence level of the second media item; changing, by the computing system, the prominence level of the second media item according to the instruction; detecting, by the computing system, that the changed prominence level of the second media item is not lower than the prominence level of the first media item; and changing, by the computing system, the hierarchical tree so that the second media item is the parent node of the first media item.

A system described herein comprises a communication module configured to obtain, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items, and receive an instruction from a user of the computing system to change the parent node of the second media item from the first media item to a third media item of the plurality of media items; and a tree logic module configured to change, by the computing system, the hierarchical tree so that the third media item is the parent node of the second media item, detect, by the computing system, that the prominence level of the second media item is not lower than the prominence level of the third media item, and change, by the computing system, the prominence level of the second media item to be lower than the prominence level of the third media item.

A non-transitory machine readable medium described herein has instructions embodied thereon, the instructions executable by one or more processors to perform operations comprising obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items; receiving an instruction from a user of the computing system to change the parent node of the second media item from the first media item to a third media item of the plurality of media items; changing, by the computing system, the hierarchical tree so that the third media item is the parent node of the second media item; detecting, by the computing system, that the prominence level of the second media item is not lower than the prominence level of the third media item; and changing, by the computing system, the prominence level of the second media item to be lower than the prominence level of the third media item.

### BRIEF DESCRIPTION OF THE DRAWINGS

FIG. 1 is an example portion of a hierarchical tree, according to an example embodiment.

FIG. 2 is a diagram of an example environment in which various embodiments can be implemented.

FIG. 3 is a simplified block diagram of a tree manager, according to an example embodiment.

FIG. 4 is a flowchart depicting a method of editing a hierarchical tree, according to an example embodiment.

FIG. 5 is an example portion of the hierarchical tree to be edited.

FIG. 6 is an example edited portion of the hierarchical tree.

FIG. 7 is a flowchart depicting a method of editing prominence level in the hierarchical tree, according to an example embodiment.

FIG. 8 is an example portion of the hierarchical tree to be edited.

FIG. 9 is an example edited portion of the hierarchical tree.

FIG. 10 is an example portion of the hierarchical tree to be edited.

FIG. 11 is an example edited portion of the hierarchical tree.

FIG. 12 depicts portions of two hierarchical trees, according to an example embodiment.

FIG. 13 depicts the portions of the two hierarchical trees to be edited.

FIG. 14 depicts the edited portions of the two hierarchical trees.

### DETAILED DESCRIPTION

A hierarchical tree is used to organize items in a media library to allow a user to quickly locate digital content such as digital media files (e.g., music, movies) by referencing similar material. A hierarchy that groups content by association, can structure complex data sets to provide effective recognition and reference. The hierarchical tree comprises parent nodes and child nodes where each node is a media item. As such, one media item can be the parent node of another media item. In prior art systems, a parent node is typically a generic label or descriptor of the child nodes. However, in the present approach, because the nodes are media items rather than generic descriptors, the re-arrangement and editing of the trees is handled differently.

The media items are each located at a particular position in the hierarchical tree and with a prominence level. The position in the hierarchical tree and the prominence level are independently editable and can, but do not necessarily, affect the other. The prominence level of a media item is a quantitative indication of its popularity relative to other, similar media items. The prominence levels can vary among children of the same parent. Even root nodes of different hierarchical trees can have varying prominence levels.

Once the media items in a media library are organized into one or more hierarchical trees, a user can personalize the hierarchical trees according to his preferences. The user can personalize the hierarchical trees by changing the positions of media items in the hierarchical trees or by changing prominence levels of the media items. The systems and methods described herein receive a user instruction affecting the prominence level or the position of some or none of the media items in the hierarchical tree (e.g., re-arrange, parent, promote, and demote media items in the hierarchical tree). Upon execution of the user instruction, the systems and methods detect whether the instruction has affected the integrity of the hierarchical trees (e.g., by causing a child media item to not have a lower prominence level than its parent). If so, the integrity of the hierarchical trees is restored automatically, and without human intervention, (e.g., by changing a position or prominence level of other media items that were not included in the user instruction).

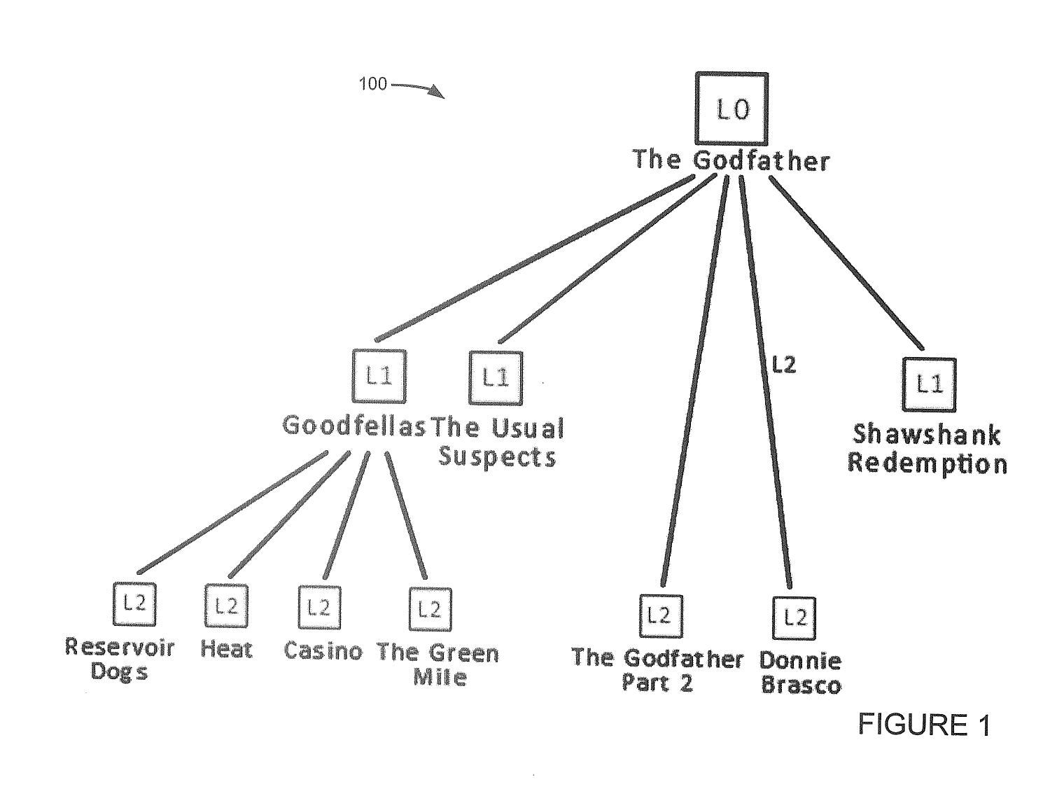

FIG. 1 is an example portion of a hierarchical tree 100, according to an example embodiment. The hierarchical tree 100 is an organization of media items into a structure that reflects similarity and relative prominence between the media items. Systems and methods for generating the hierarchical tree and prominence levels are described in U.S. patent application Ser. No. 14/214,372, of which this application is a continuation application.

The editable hierarchical tree 100 has leaf and non-leaf nodes that are media items. Assigning media items as non-leaf nodes and, therefore, representatives for a tree or a sub-tree means the media item (for example, “The Godfather”) stands for and represents an entire tree or sub-tree (for example, “Crime” movies). A media library typically includes multiple hierarchical trees, with each hierarchical tree having a root node or representative and each sub-tree having its own representative. The root media item can have children of different prominence levels. The trees can be laid out such that each tree is radial around the root node, creating clusters and sub-clusters of representative content. Via a user interface, the user can zoom in and out, where representatives fade in and out as different levels of detail are shown.

In the hierarchical trees, every node has a distinct prominence level. The prominence levels start at the most prominent (and, in an embodiment, largest when displayed on the screen) labeled “L0,” and progress to lower levels of prominence such as L1, L2, L3, L4, L5, etc. (it is to be noted that, as is thus clear, a lower prominence number represents a higher prominence level). The prominence level of a given media item can be represented in the form PROM_LEVEL(media), which outputs an Lx value. The prominence level of the media item is not directly linked to its position within the hierarchical tree structure, but is initially a calculated prominence value indicating the relative popularity of the media item and can be adjusted by the user. The prominence level can be used to determine how the media item is depicted within a user interface (e.g., media items having a higher prominence level can be depicted by icons that are larger than icons that represent media items having a lower prominence level).

Based on the diversity of the media items, the media library can be organized into a number of trees, each having their representative element (the most prominent element) as the top of their hierarchical tree. The user, through a user interface action such as clicking-and-dragging content on the screen (with mouse or touch gesture), is able to manipulate the obtained hierarchical trees and rearrange items and sub-trees within them. The user can even move items and sub-trees from one tree to another as described in greater detail below.

When the hierarchical trees are obtained, the child nodes within the hierarchical tree are invariably at a prominence level that is lower than the prominence level of its parent. The prominence values can be edited and adjusted by the user and the system reacts to maintain the integrity of the hierarchical tree by updating the prominence levels of other media items within the hierarchical tree, as needed and as is described herein.

Referring again to FIG. 1, hierarchical tree 100 is shown having media items (in this example, movies) with prominence levels. Each media item that is a node in the hierarchical tree has a prominence level shown internal to the square adjacent to the label identifying the media item. In FIG. 1, “The Godfather” is the L0 root node of a hierarchical tree that has “Goodfellas” as an L1 representative node for the children: “Reservoir Dogs”, “Heat”, “Casino”, and “The Green Mile”. “The Usual Suspects” and “Shawshank Redemption” have no children (and only represent themselves because they have no children) and are denoted as L1, which means they are at the same prominence level as “Goodfellas”. “The Godfather Part 2” and “Donnie Brasco” are denoted as L2, but are parented to (and are thus represented by) only “The Godfather”. This means that “The Godfather” is both their L0 and L1 representative. “The Godfather Part 2” and “Donnie Brasco” (both denoted as L2) have the same prominence level as “Reservoir Dogs”, “Heat”, etc. (other L2 items) but they are positioned below or around “The Godfather” when the hierarchical tree is displayed.

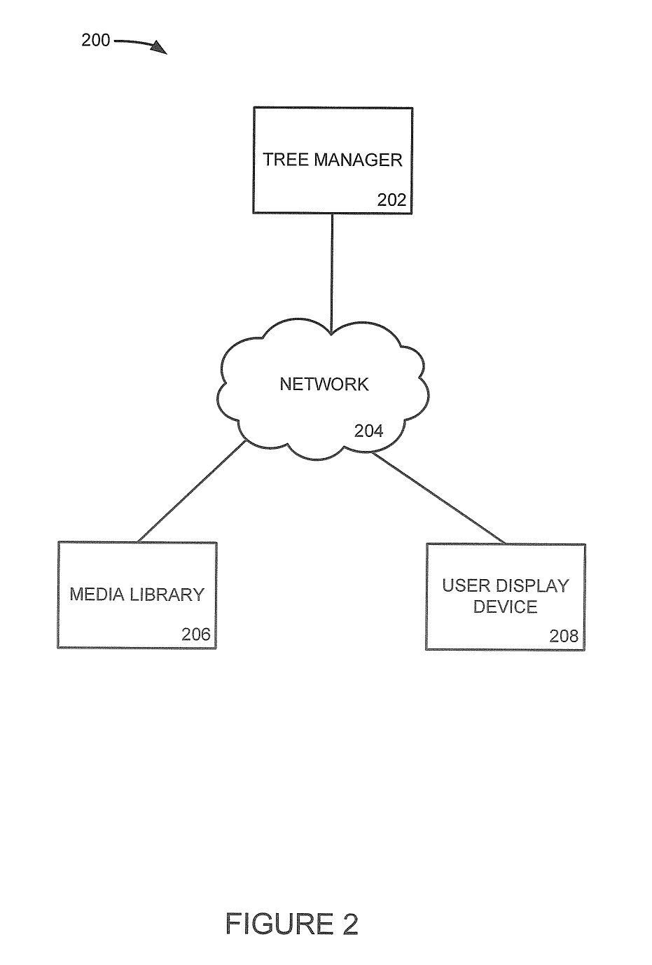

Referring now to FIG. 2, a diagram of an example environment 200 is shown in which various embodiments can be implemented. In the example environment 200, a tree manager 202 is configured to obtain and facilitate editing of a hierarchical tree via a network 204 (e.g., the Internet). The tree manager 202 can obtain the media items (or identifiers thereof) and/or the hierarchical tree from one or more media libraries 206. The tree manager 202 can transmit the hierarchical tree to one or more user display devices 208 for display and editing. Each of the user display devices 208 can receive an instruction from the user to change the hierarchical tree and transmit the instruction over the network 204 to the tree manager 202.

The tree manager 202 obtains the hierarchical tree from the one or more media libraries 206 or from a similarity system (e.g., the similarity system described in U.S. patent application Ser. No. 14/214,372, of which this patent application is a continuation) via the network 204. In some instances, the similarity system and/or at least one of the media libraries 206 can be co-located with the tree manager 202. The tree manager 202 is configured to receive instructions from a user using the user display device 208 (e.g., via the network 204) to change a position of a media item in a hierarchical tree or to change a prominence level of a media item in the hierarchical tree. The tree manager 202 then executes the instruction and makes changes to the position or prominence level of media items in the hierarchical tree as necessitated by the instruction.

The tree manager 202 can be implemented in a variety of ways known to those skilled in the art including, but not limited to, as a computing device having a processor with access to a memory capable of storing executable instructions for performing the functions of the described modules. The computing device can include one or more input and output components, including components for communicating with other computing devices via a network (e.g., the network 204) or other form of communication. The tree manager 202 comprises one or more modules embodied in computing logic or executable code such as software.

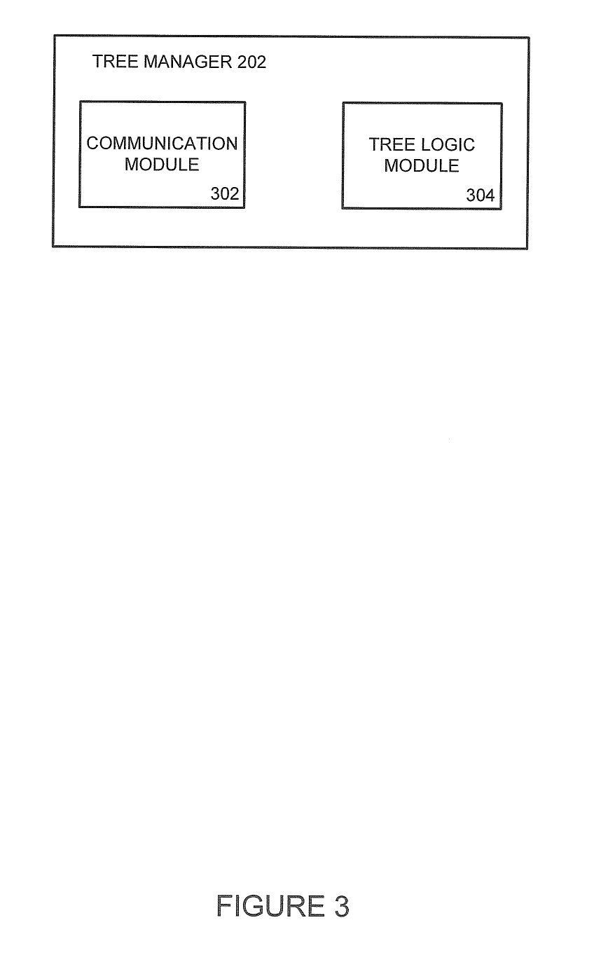

Referring now to FIG. 3, a simplified block diagram of tree manager 202 is shown, according to an example embodiment. The tree manager 202 comprises a communication module 302 and a tree logic module 304.

The communication module 302 is configured to obtain one or more hierarchical trees that organize a media library and to obtain the prominence levels of the media items in the hierarchical tree. The communication module 302 can provide a display of the hierarchical trees to the user display device 208. The communication module 302 receives instructions from a user to modify the hierarchical tree by changing a position of a media item within the tree or to change a prominence level of a media item. After the hierarchical trees are edited, the communication module 302 can provide a display of the edited hierarchical trees to the user display device 208.

The tree logic module 304 is configured to change the hierarchical tree or the prominence level of at least one of the media items in response to the instructions received from the user. The tree logic module 304 can detect if a change in prominence level further necessitates a change in the hierarchical tree or if a change in the position of a media item in the hierarchical tree necessitates a change in prominence level of one or more of the media items. The tree logic module 304 can make those changes to the hierarchical tree or to the prominence levels of the media items.

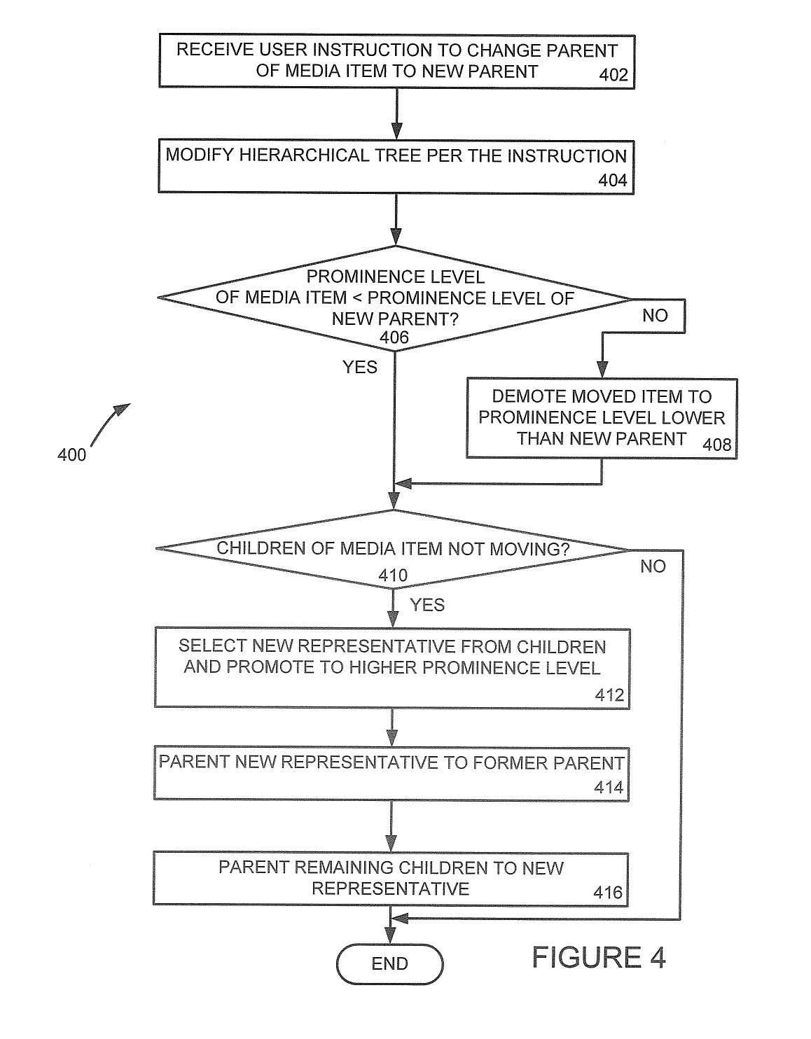

FIG. 4 is a flowchart depicting a method 400 of editing a hierarchical tree by changing the position of a media item in the hierarchical tree, according to an example embodiment. The method 400 can be performed by the tree manager 202 after the hierarchical trees and prominence levels are obtained.

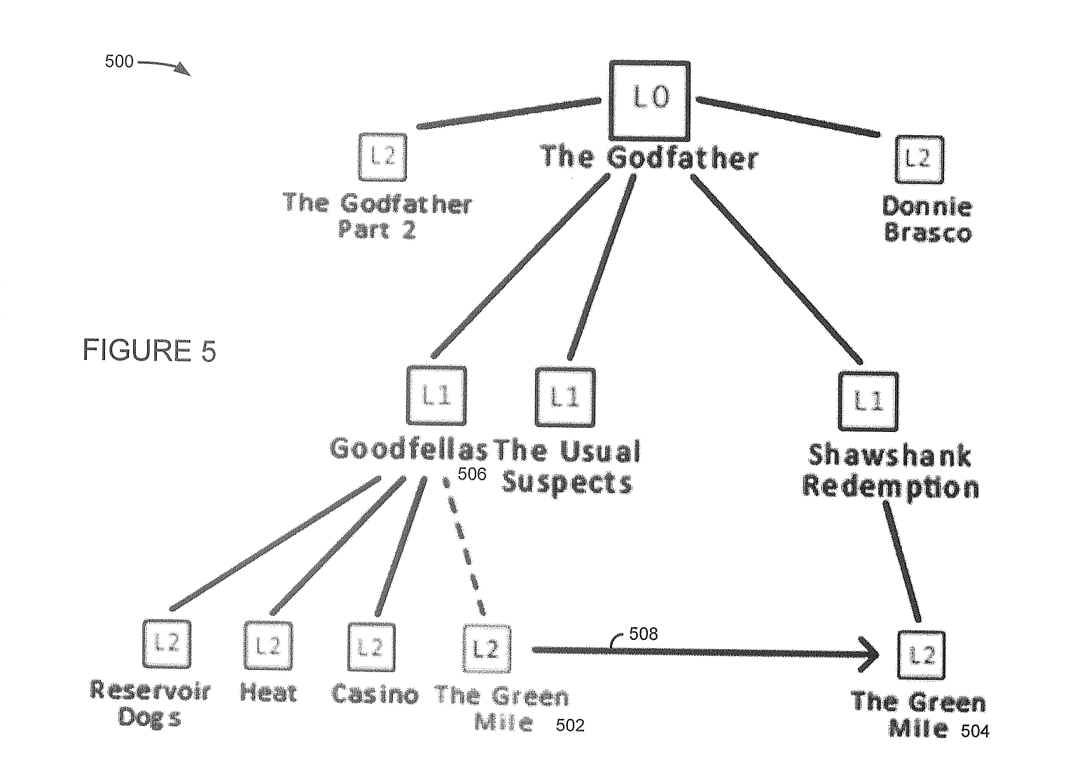

In an operation 402, an instruction to change a parent node of a media item to a new parent is received from the user. The user can re-parent a media item, which means the user moves a media item closer on the screen (e.g., via dragging with a mouse or gesture) to another media item that is not its parent. This new parent can be either within the same tree or within another tree. For example, starting with FIG. 5, in the hierarchical tree 500, the user might decide “The Green Mile” 502 is more closely related to “Shawshank Redemption” 504 than “Goodfellas” 506 and move the media item towards “Shawshank Redemption,” as depicted by arrow 508. In some instances, the hierarchical tree is edited when the moved media item is closer (based on the display distance on the screen displaying the hierarchical tree to the user) to the new parent than it is to its former parent.

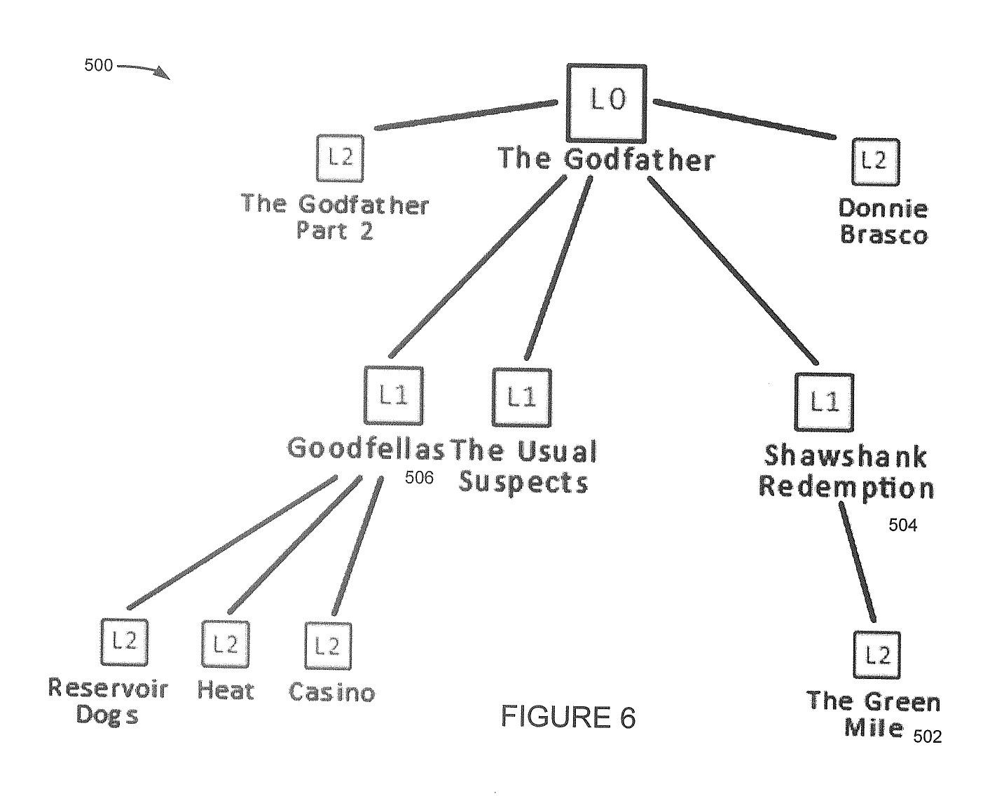

Returning to FIG. 4, in an operation 404, the hierarchical tree is modified per the instruction. As depicted in FIG. 6, an example edited portion of the hierarchical tree 500, the position of the film “The Green Mile” 502 is changed from being parented by “Goodfellas” 506 to being parented by “The Shawshank Redemption” 504.

Referring again to FIG. 4, in an operation 406, a determination is made as to whether the prominence level of the moved media item is lower than that of its new parent. If the prominence level of the moved media item is lower than that of its new parent, then the movement of the moved media item does not necessitate a change in prominence level of the moved media item, and the method 400 proceeds to operation 410, discussed below. Returning to the example depicted in FIG. 6, the moved media item, “The Green Mile” 502 has a prominence level L2 and the new parent, “The Shawshank Redemption” 504 has a prominence level L1. Because L2 is lower than L1, the change in position of “The Green Mile” 502 does not necessitate a change in prominence level of the moved media item.

Returning to FIG. 4, in an operation 408, if the change in position of the moved media item results in the prominence level of the moved media item being equal to or greater than the prominence level of its new parent, the moved media item is demoted by being changed to a prominence level lower than the prominence level of its new parent. The prominence level of the new parent does not change.

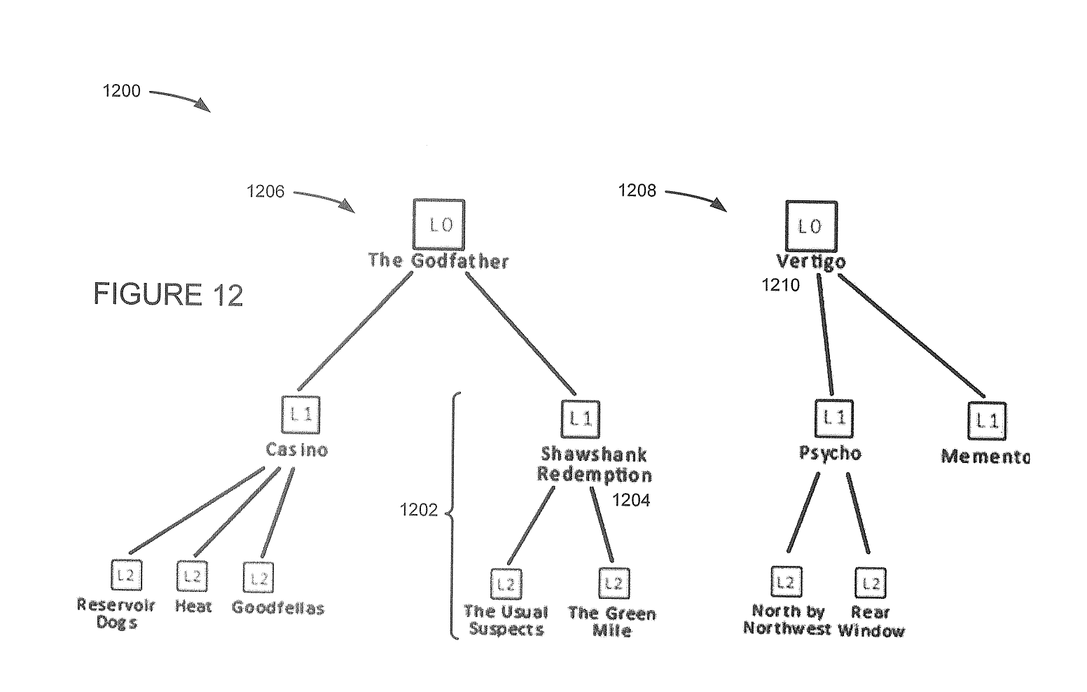

In some instances, the moved media item can have been the parent of one or more other media items before it was moved. The instruction received from the user, however, can instruct that only the moved media item be moved to the new parent node without moving the children of the moved media item, as is described below. Movement of the children of the moved media item with the moved media item is described below, in connection with FIGS. 12-14. In operation 410, a determination is made as to whether the moved item has children that were not moved with the moved media item.

In an operation 412, if the moved media item has children media items that are not being moved, a new representative is selected from the children. If the moved media item had only one child, that child is selected. The selection of the representative can be based, for example, on the prominence scores of the children, where the child having a highest prominence score is selected. The prominence score of the media item is a calculated value on which the prominence level of the media item is based. The prominence score is calculated as described in U.S. patent application Ser. No. 14/214,372 of which this patent application is a continuation. If not already at a higher prominence level than the remaining children, the selected representative is promoted to a higher prominence level so that the remaining children each have a lower prominence level than the selected media item.

In an operation 414, the selected media item is re-positioned in the hierarchical tree as the child node of the former parent of the moved media item.

In an operation 416, the remaining children media items are made the child nodes of the selected media item.

Returning to operation 410, if the children of the media item are moving along with the moved item (i.e., following the “NO” branch from the operation 410), one or more additional operations can be performed. After following the “NO” branch, a further determination can be made as to whether the prominence level of the moved media item has been changed to a lower prominence level. If the prominence level of the media item is changed to a lower prominence level, the prominence levels of the moved child media item is also lowered by a same number of prominence levels as its parent, the moved media item.

Referring again to FIG. 6, in further instances, the user can move an L2 child of an L1 parent close enough to the L0 representative to make the L2 child parent from the L0 representative. For example, the user can move an L2 child (e.g., “Reservoir Dogs”) close enough to the L0 representative, “The Godfather,” to change the parent of the L2 child from its L1 parent, “Goodfellas,” to the L0 representative, “The Godfather”. This movement does not change any prominence levels because the child node remains at a prominence level that is lower than that of its new parent.

Instead of changing the position of the media item in the hierarchical tree, the user can decide to change its prominence level so that the hierarchical tree better reflects the user's personal preferences and taste in, for example, movies or music. The prominence level can be changed by, for example, clicking a button within a user interface of the user display device 208 instead of dragging-and-dropping media items. The system then maintains the invariant of higher-level prominence elements always being above (and parenting) lower-level prominence elements, by automatically demoting the parent and adjusting parentage as needed.

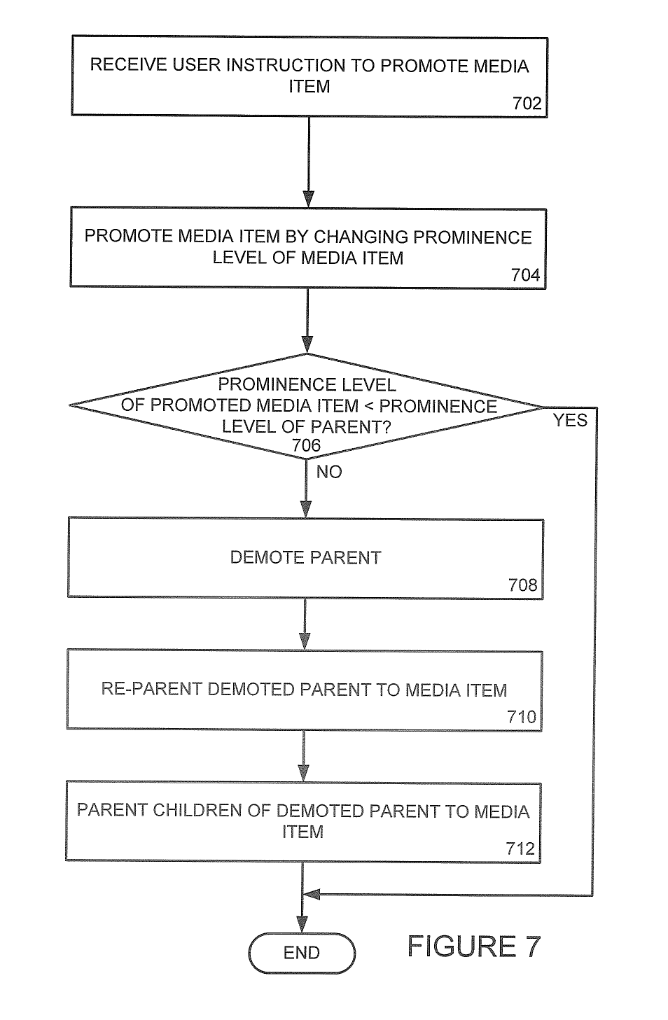

FIG. 7 is a flowchart depicting a method 700 of editing a prominence level of a media item in the hierarchical tree, according to an example embodiment. The method 700 can be performed by the tree manager 202 after the hierarchical trees and prominence levels are obtained.

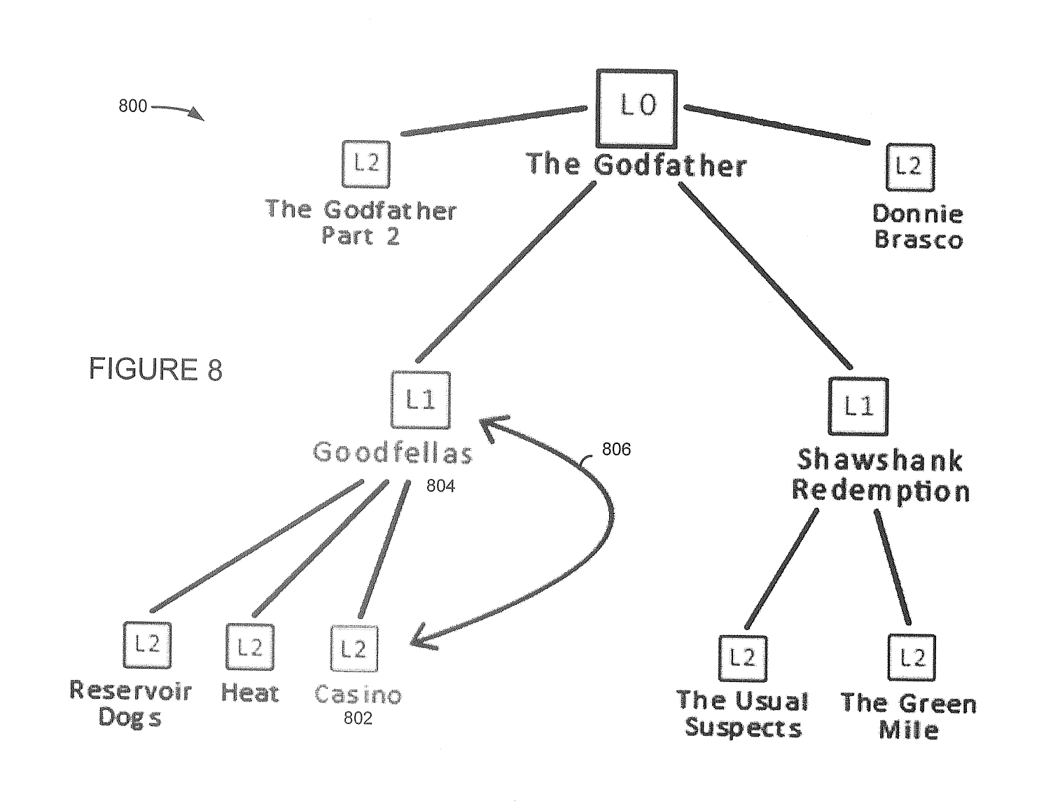

In an operation 702, an instruction is received from a user to promote a media item by assigning the media item a prominence level that is higher than its current prominence level. Referring to FIG. 8, an example portion of the hierarchical tree 800 to be edited, the user might decide “Casino” 802 better represents the group of media items currently represented by “Goodfellas” 804. The user provides an instruction to promote “Casino” 802 by, e.g., clicking a button. The instruction instructs the tree manager 202 to promote “Casino” 802 from prominence level L2 to prominence level L1, as indicated by arrow 806.

Returning to FIG. 7, in an operation 704, the media item is promoted to the higher prominence level by changing its prominence level. Continuing the example of FIG. 8, the prominence level of “Casino” 802 is changed from prominence level L2 to prominence level L1.

In an operation 706, a determination is made as to whether the prominence level of the promoted media item is lower than the prominence level of its parent media item. If the promoted media item still has a lower prominence level than its parent, no further adjustments are necessitated by the promotion.

If, however, the prominence level of the promoted media item is not lower than (i.e., is higher than or equal to) that of its parent, the parent media item is demoted in an operation 708. The parent media item is demoted by changing its prominence level to a prominence level that is lower than that of the promoted media item. In the example depicted in FIG. 8, when “Casino” 802 is promoted to prominence level L1, its L1 parent, “Goodfellas,” 804 is demoted by changing its prominence level to prominence level L2.

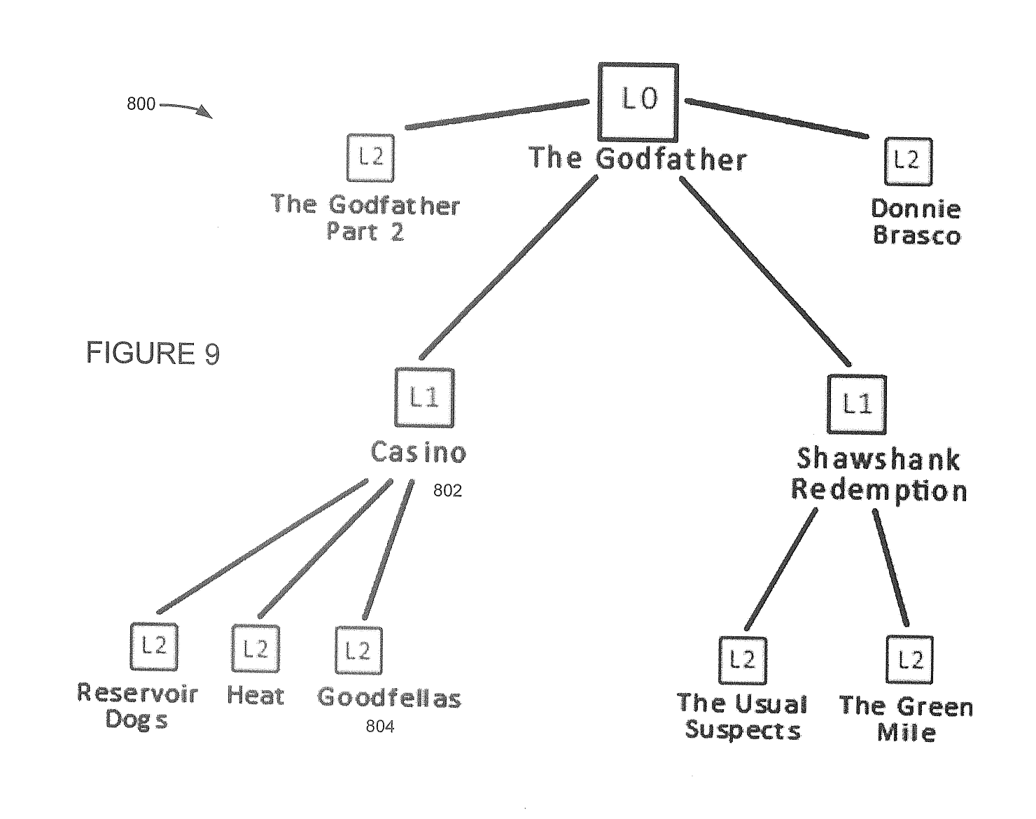

In an operation 710, the demoted parent is re-parented to the promoted media item. Referring to FIG. 9, an example edited portion of the hierarchical tree of FIG. 8, the demoted parent, “Goodfellas,” 804 becomes a child node of the promoted media item “Casino” 802. The promoted media item is also re-parented to the former parent of the demoted parent.

In an operation 712, the children of the demoted parent are re-parented to the promoted media item. Referring to the example in FIG. 9, the media items “Reservoir Dogs” and “Heat” are parented to “Casino” 802 rather than “Goodfellas” 804.

Although the example of FIGS. 8 and 9 shows a single media item being promoted, a sub-tree within the hierarchical tree can be promoted. To promote a sub-tree, the root media item of the sub-tree and all of its children are each increased by one prominence level and moved up the tree. In instances where a child media item has a higher prominence level than its parent as a result of the sub-tree being promoted, the parenting and/or positioning of the media items is adjusted outside of the sub-tree.

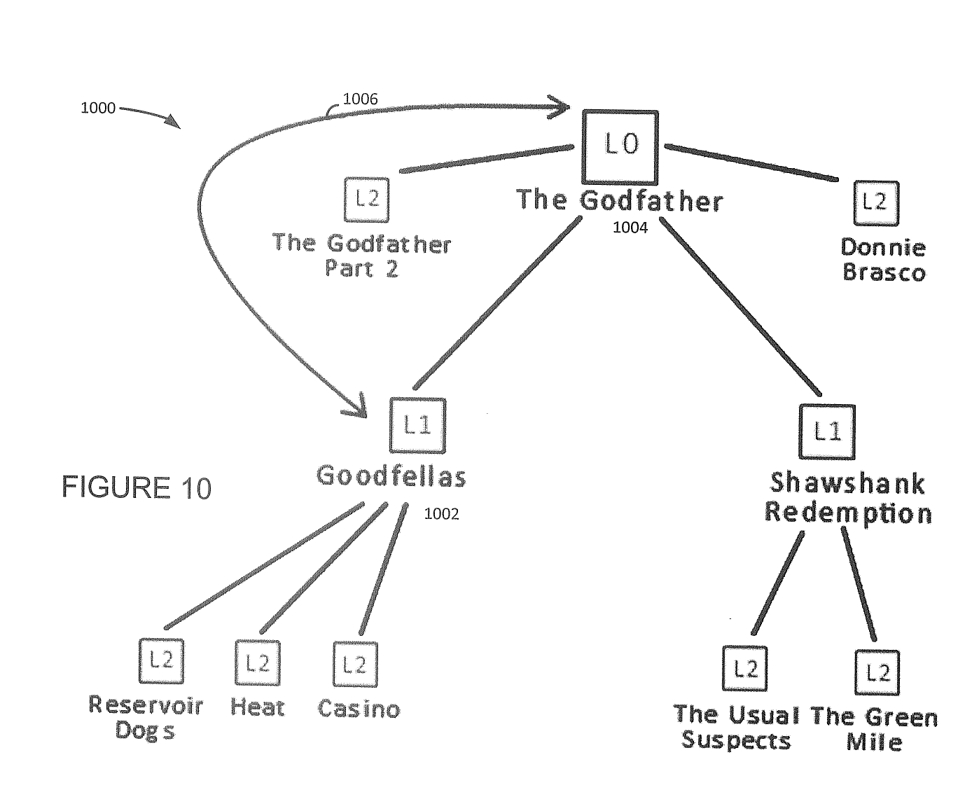

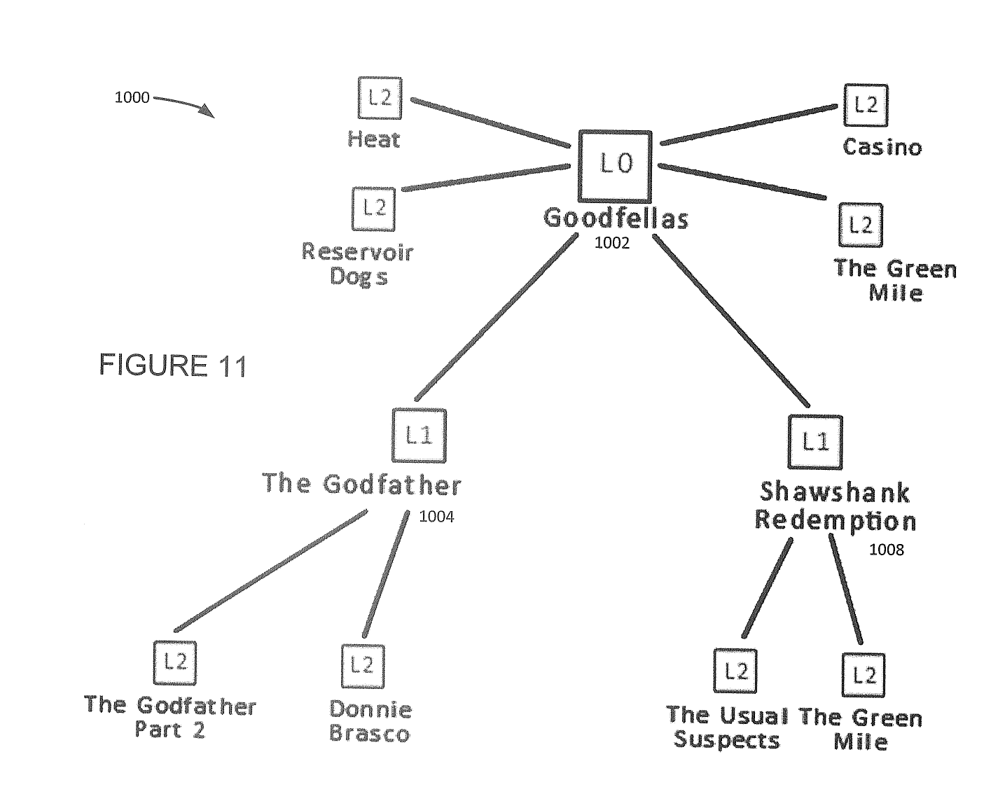

FIGS. 10 and 11 depict a further example of the method 700 where a root node of a hierarchical tree is changed by changing the prominence level of a child node. As depicted in FIG. 10, an example portion of the hierarchical tree 1000 to be edited, the user might decide “Goodfellas” 1002 is the best representative for the hierarchical tree 1000 represented by the root node “The Godfather” 1004. Following the method 700, the user promotes “Goodfellas” 1002 by, e.g., clicking a button to instruct the tree manager 202 to promote “Goodfellas” 1002 to a higher prominence level (e.g., from prominence level L1 to prominence level L0) (operation 702), as indicated by the arrow 1006.

In the operation 704, the prominence level of “Goodfellas” 1002 is changed from L1 to L0. In the operation 706, the new prominence level of “Goodfellas” 1002 (L0) is compared with the prominence level of its parent in the hierarchical tree, “The Godfather” 1004 (L0). Because the prominence levels are equal, in operation 708, the parent, “The Godfather” 1004 is demoted to prominence level L1.

As depicted in FIG. 11, an example edited portion of the hierarchical tree 1000, and according to the operation 710, “The Godfather” 1004 is parented to “Goodfellas” 1002. In the operation 712, the L1 child, “The Shawshank Redemption,” 1008 of “The Godfather” 1004 is re-parented to “Goodfellas” 1002, and the L2 children of that child remain otherwise unchanged. The L2 children of “The Godfather” 1004 (“The Godfather Part 2” and “Donnie Brasco”) are not re-parented to “Goodfellas” 1002 because L2 is a lower prominence than L1, the new prominence level of “The God father” 1004.

In some instances, a user can move a sub-tree comprising two or more media items. As described above, a user can instruct that a media item be moved with or without moving its child media items (see, e.g., operation 410). Moving a sub-tree occurs when the user's instruction indicates that the child media items be moved with the moved media item. In an embodiment, if the user clicks once on a media item, the user effects the selection of the sub-tree, thus instructing that the media item and its children are to be moved. If, in this embodiment, the user clicks on the media item a second time, the user effects the de-selection of the sub-tree, thus instructing that only the media item be moved. The sub-tree can be moved into another position in the same hierarchical tree (e.g., re-parenting a sub-tree within the same hierarchical tree) or to another hierarchical tree (e.g., by re-parenting the sub-tree outside the hierarchical tree). In both of these cases, a new parent is selected and the media items are positioned as child nodes of the new parent in the hierarchical tree.

By moving a sub-tree to an area of the user interface that is away from the other media items in hierarchical trees (e.g., not within a pre-defined distance of the other media items), the user can provide an instruction to create a new and separate hierarchical tree with the root node of the moved sub-tree as the root node for this new hierarchical tree.

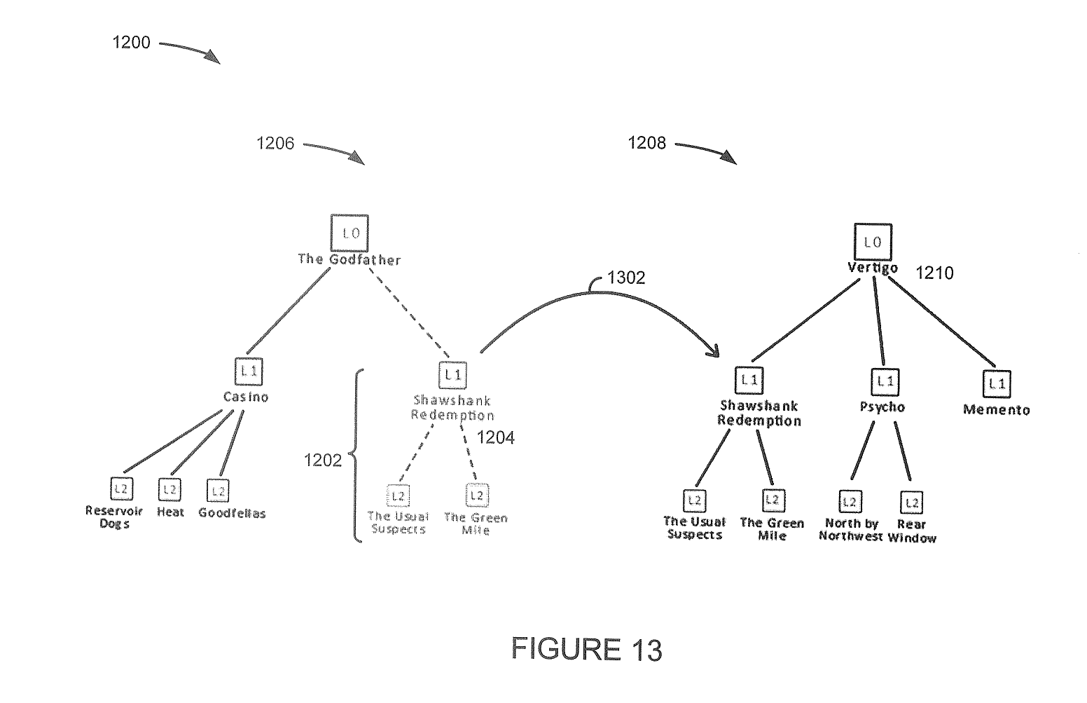

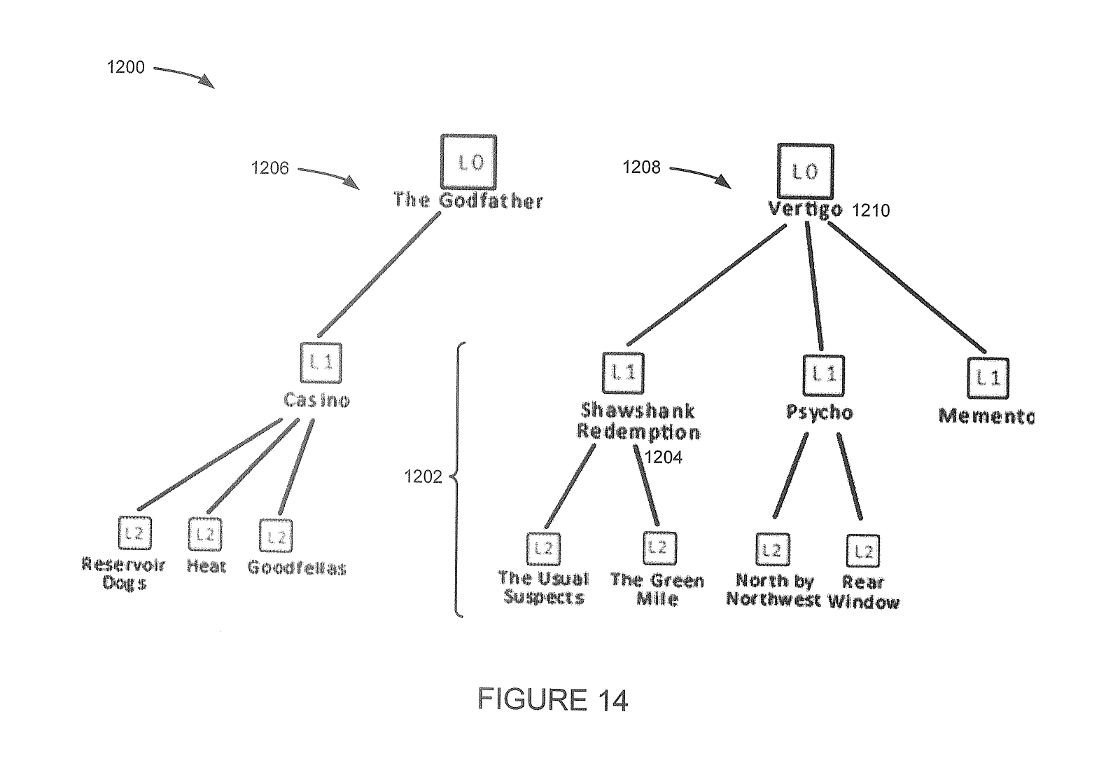

Similar to the method 400 of FIG. 4, to move the sub-tree, an instruction is received from the user (e.g., the operation 402). The instruction identifies the sub-tree to be moved by its root node. As illustrated in FIGS. 12 and 13, via a user interface displaying hierarchical trees 1200, the user moves a sub-tree 1202 represented by its root node, “The Shawshank Redemption” 1204 from a first hierarchical tree 1206 having “The Godfather” as its root node to a second hierarchical tree 1208 having “Vertigo” 1210 as its root node. More specifically, the instruction indicates that the sub-tree is to be moved into a position underneath the media item “Vertigo” 1210, as depicted by the arrow 1302 in FIG. 13. In this case, the user is moving a sub-tree, which can be a default behavior when the user clicks-and-drags a media item in the interface. FIG. 14 depicts the edited portions of the two hierarchical trees. Because the prominence level of “The Shawshank Redemption” (L1) is lower than the prominence level of “Vertigo” (L0), no changes in the prominence levels are necessitated by the move.

Using the systems and methods described herein, a user can edit the organization of media items within a hierarchical tree. Each of the media items is organized by its position in the hierarchical tree and by its prominence level. The integrity of the hierarchical tree depends on the prominence level of a child node being lower than the prominence level of its parent node. If a change in either the position of a media item in the hierarchical tree or the prominence level of the media item causes a child media item to not have a lower prominence level, the systems and methods described herein automatically, without human intervention, change the organization of the media items so as to comply.

The disclosed method and apparatus has been explained above with reference to several embodiments. Other embodiments will be apparent to those skilled in the art in light of this disclosure. Certain aspects of the described method and apparatus may readily be implemented using configurations other than those described in the embodiments above, or in conjunction with elements other than those described above. For example, different algorithms and/or logic circuits, perhaps more complex than those described herein, may be used.

Further, it should also be appreciated that the described method and apparatus can be implemented in numerous ways, including as a process, an apparatus, or a system. The methods described herein may be implemented by program instructions for instructing a processor to perform such methods, and such instructions recorded on a non-transitory computer readable storage medium such as a hard disk drive, floppy disk, optical disc such as a compact disc (CD) or digital versatile disc (DVD), flash memory, etc., or communicated over a computer network wherein the program instructions are sent over optical or electronic communication links. It should be noted that the order of the steps of the methods described herein may be altered and still be within the scope of the disclosure.

It is to be understood that the examples given are for illustrative purposes only and may be extended to other implementations and embodiments with different conventions and techniques. While a number of embodiments are described, there is no intent to limit the disclosure to the embodiment(s) disclosed herein. On the contrary, the intent is to cover all alternatives, modifications, and equivalents apparent to those familiar with the art.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method comprising:
obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items;
receiving an instruction from a user of the computing system to change the parent node of the second media item from the first media item to a third media item of the plurality of media items;
changing, by the computing system, the hierarchical tree so that the third media item is the parent node of the second media item;
detecting, by the computing system, that the prominence level of the second media item is not lower than the prominence level of the third media item; and
changing, by the computing system, the prominence level of the second media item to be lower than the prominence level of the third media item.

2. The method of claim 1, further comprising:
receiving a further instruction from the user of the computing system to change the parent node of a fourth media item of the plurality of media items from the first media item to a fifth media item of the plurality of media items, the fifth media item being the parent node of the first media item;
changing the hierarchical tree so that the fifth media item is the parent node of the fourth media item;
detecting that the prominence level of the fourth media item is lower than the prominence level of the fifth media item; and
not changing the prominence level of the fourth media item.

3. The method of claim 1, wherein the second media item is the parent node of two or more media items of the plurality of media items, and wherein the method further comprises:
selecting one of the two or more media items to become a parent node of remaining media items of the two or more media items;
changing the hierarchical tree so that the selected one of the two or more media items is the parent node of the remaining media items and a child node of the first media item; and
changing the prominence level of the selected one of the two or more media items to a prominence level that is higher than a highest prominence level of the remaining media items.

4. The method of claim 3, wherein selecting one of the two or more media items to become the parent node is based on prominence scores of the two or more media items.

5. The method of claim 1, wherein the second media item is the parent node of two or more media items of the plurality of media items, and further comprising, after changing the prominence level of the second media item:
detecting, by the computing system, that the prominence level of at least one of the two or more media items is not lower than the prominence level of the second media item; and
changing, by the computing system, the prominence level of the at least one of the two or more media items so that the prominence level of the at least one of the two or more media items is lower than the prominence level of the second media item.

6. The method of claim 1, wherein the media item is one of a film, an audio recording, or an image.

7. A method comprising:
obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items;
receiving an instruction from a user of the computing system to change the prominence level of the second media item;
changing, by the computing system, the prominence level of the second media item according to the instruction;
detecting, by the computing system, that the changed prominence level of the second media item is not lower than the prominence level of the first media item; and
changing, by the computing system, the hierarchical tree so that the second media item is the parent node of the first media item.

8. A system comprising:
a communication module configured to:
obtain, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items, and
receive an instruction from a user of the computing system to change the parent node of the second media item from the first media item to a third media item of the plurality of media items; and
a tree logic module configured to:
change, by the computing system, the hierarchical tree so that the third media item is the parent node of the second media item,
detect, by the computing system, that the prominence level of the second media item is not lower than the prominence level of the third media item, and
change, by the computing system, the prominence level of the second media item to be lower than the prominence level of the third media item.

9. The system of claim 8, wherein the communication module is further configured to:
receive an instruction from a user of the computing system to change the prominence level of a third media item.

10. The system of claim 9, wherein the tree logic module is further configured to:
change, by the computing system, the prominence level of the third media item according to the instruction;
detect, by the computing system, that the changed prominence level of the third media item is not lower than the prominence level of its parent media item; and
change, by the computing system, the hierarchical tree so that the second media item is the parent node of the parent media item.

11. A non-transitory machine readable medium having instructions embodied thereon, the instructions executable by one or more processors to perform operations comprising:
obtaining, by a computing system, a hierarchical tree of nodes wherein each node is one of a plurality of media items each having a prominence level, the prominence level indicative of a relative popularity of the media item, and wherein a first media item of the plurality of media items is a parent node of a second media item of the plurality of media items;
receiving an instruction from a user of the computing system to change the parent node of the second media item from the first media item to a third media item of the plurality of media items;
changing, by the computing system, the hierarchical tree so that the third media item is the parent node of the second media item;
detecting, by the computing system, that the prominence level of the second media item is not lower than the prominence level of the third media item; and
changing, by the computing system, the prominence level of the second media item to be lower than the prominence level of the third media item.

12. A method comprising:
obtaining, by a computing system, a first hierarchical tree of nodes wherein each node is one of a plurality of media items each having a prominence level, the prominence level indicative of a relative popularity of the media item, and wherein a first media item of the plurality of media items is a parent node of a second media item of the plurality of media items;
receiving an instruction from a user of the computing system to generate a second hierarchical tree of nodes having the first media item as a root node and the second media item as a child node;
changing, by the computing system, the prominence level of the first media item by a number of prominence levels; and
changing, by the computing system, the prominence level of the second media item in the second hierarchical tree by the number of prominence levels.
